(19) United States
(12) Patent Application Publication
(10) Pub. No.: US 2023/0246975 A1
(43) Pub. Date: Aug. 3, 2023

(54) METHOD AND DEVICE FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/127,015

(22) Filed: Mar. 28, 2023

Related U.S. Application Data
(63) Continuation of application No. PCT/CN2021/120817, filed on Sep. 27, 2021.

(30) Foreign Application Priority Data
Sep. 29, 2020 (CN) 202011049552.3

(51) Int. Cl. H04L 47/34; H04W 28/04; H04L 1/18

(52) U.S. Cl. CPC H04L 47/34; H04W 28/04; H04L 1/18

(57) ABSTRACT

The present application discloses a method and device for wireless communications, comprising receiving a first Packet Data Convergence Protocol (PDCP) Protocol Data Unit (PDU), and the first PDCP PDU comprising a first PDCP sequence number; in response to there existing PDCP SDU(s) indexed by X1 PDCP sequence number(s) in a target PDCP sequence number set not being correctly received, transmitting a first report; wherein the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X. The present application improves resource utilization and reduces resource waste by transmitting a first report.

### CROSS REFERENCE TO RELATED APPLICATIONS

This application is the continuation of the international patent application No. PCT/CN2021/120817, filed on Sep. 27, 2021, and claims the priority benefit of Chinese Patent Application No. 202011049552.3, filed on Sep. 29, 2020, the full disclosure of which is incorporated herein by reference.

### BACKGROUND

### Technical Field

The present application relates to transmission methods and devices in wireless communication systems, in particular to a transmission method and device for improving system efficiency, optimizing resource utilization, reducing service interruption, avoiding resource waste, saving power, enhancing service continuity and improving reliability in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), Dual connectivity system, and in the mixture of the above communication modes, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

### SUMMARY

In various communication scenarios, especially in wireless networks that support the new generation Multicast Broadcast Service (NIBS), reliable transmission of data is involved, such as overall firmware upgrade for a large number of Internet of Things devices, broadcast multicast communications for the Internet of Vehicles, which require higher reliability assurance. To meet higher reliability requirements, it is necessary to use a retransmission mechanism. Retransmission technologies that mainly involve physical layer and MAC layer can be used, such as HARQ, or L2 retransmission technology can be used, such as ARQ. When MBS services use Point to Multipoint (PTM) transmission, the method of its data transmission differs greatly from that of Point to Point (PTP) transmission, so that the retransmission methods may also have significant differences and need to be considered separately. On the other hand, the transmission technology of MBS service also has its own requirements, for example, it is required to reduce data loss as much as possible when the transmission mode is converted from PTP to PTM or from PTM to PTP. As for retransmission, the basic method comprises a retransmission that a receiving user feeds back a report of its missing data, and then a transmitter responds to it. For MBS, the technical difficulties involved comprise which layer and entity is responsible for generating reports, and different methods can affect data continuity during PTP and PTM switching, as well as the complexity of the entire system design; at the same time, when to generate and transmit these reports is also a very important issue, if handled improperly, it can lead to a significant delay in service reception, which can lead to unnecessary retransmission requests being generated, thereby wasting uplink resources; therefore, a good retransmission method needs to consider multiple aspects and be carefully designed. In addition, the functions of different layers of NR have their own unique features, for example, PDCP entities have the functions of disordered transmission and sequential transmission, and the data transmitted by RLC entities may be disordered, which brings new difficulties to the control of reports and is difficult to learn from previous experience. If the architecture and basic methods of NR itself is not respect, it will cause great complexity to the system, thereby losing practical value; the present application provides an ideal method for determining the content of the report at right time, balancing multiple needs, and having a low complexity in implementation, which effectively solves the above problems.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:

receiving a first Packet Data Convergence Protocol (PDCP) Protocol Data Unit (PDU), the first PDCP PDU comprising a first PDCP sequence number; and

in response to there existing PDCP Service Data Unit(s) (SDU(s)) indexed by X1 PDCP sequence number(s) in a target PDCP sequence number set not being correctly received, transmitting a first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, a problem to be solved in the present application comprises: how to determine which PDCP SDUs need retransmission and when to transmit reports to assist the transmitter in retransmission when transmitting services such as broadcast multicast that require reliability in PTM mode. The present application solves the above problem by determining a target PDCP sequence number set and transmitting a first report comprising a first PDCP sequence number set to appropriately indicate data that needs to be retransmitted.

In one embodiment, advantages of the above method comprise: a PDCP sequence number comprised in a first PDCP sequence number set indicated in a first report can indicate a set of sequence numbers corresponding to PDCP SDUs that are not determined to be received, that is, a part of a target PDCP sequence number set is not equal or the target PDCP sequence number set is not completely equal, which is conducive to establishing a balance between latency and resource consumption to transmit a first report with fewer resources, thereby being conducive to improving resource utilization as well as increasing continuity of data and service and the reliability of data transmission.

Specifically, according to one aspect of the present application, a first signaling is received, the first signaling indicates X2;

herein, order of PDCP sequence numbers in the target PDCP sequence number set is continuous, and a number of PDCP sequence number(s) between a last PDCP sequence in the target PDCP sequence number set and the first PDCP sequence number is X2.

Specifically, according to one aspect of the present application, a second signaling is received, and the second signaling indicates X3 time unit(s);

herein, order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

Specifically, according to one aspect of the present application, X1 is equal to X, and order of a last PDCP sequence number in the target PDCP sequence number set and the first PDCP sequence number are continuous.

Specifically, according to one aspect of the present application, a second PDCP sequence number belongs to the target PDCP sequence number set, and the second PDCP sequence number indexes a second PDCP SDU; the second PDCP sequence number is determined belonging to the target PDCP sequence number set, which is used to start a first timer; an expiration of the first timer is used to trigger the behavior of transmitting the first report; the first PDCP sequence number set comprises the second PDCP sequence number.

Specifically, according to one aspect of the present application, the first PDCP PDU is used to bear a first non-unicast service;

a third signaling is received, the third signaling is used to configure a discontinuous reception of the first non-unicast service; when the first report is transmitted, a reception of the first non-unicast service is in inactive state.

Specifically, according to one aspect of the present application, at least one of PDCP SDUs indexed by the first PDCP sequence number set is received.

Specifically, according to one aspect of the present application, the first node is a UE.

Specifically, according to one aspect of the present application, the first node is an Internet of Things (IoT) terminal.

Specifically, according to one aspect of the present application, the first node is a relay.

Specifically, according to one aspect of the present application, the first node is a vehicle terminal.

Specifically, according to one aspect of the present application, the first node is an aircraft.

The present application provides a method in a second node for wireless communications, comprising:

transmitting a first PDCP PDU, the first PDCP PDU comprising a first PDCP sequence number;

receiving a first report; a transmitter of the first report, in response to there existing PDCP SDU(s) indexed by X1 PDCP sequence number(s) in a target PDCP sequence number set not being correctly received, transmitting the first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

Specifically, according to one aspect of the present application, a first signaling is transmitted, the first signaling indicates X2;

herein, order of PDCP sequence numbers in the target PDCP sequence number set is continuous, and a number of PDCP sequence number(s) between a last PDCP sequence in the target PDCP sequence number set and the first PDCP sequence number is X2.

Specifically, according to one aspect of the present application, a second signaling is transmitted, and the second signaling indicates X3 time unit(s);

herein, order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

Specifically, according to one aspect of the present application, X1 is equal to X, and order of a last PDCP sequence number in the target PDCP sequence number set and the first PDCP sequence number are continuous.

Specifically, according to one aspect of the present application, a second PDCP sequence number belongs to the target PDCP sequence number set, and the second PDCP sequence number indexes a second PDCP SDU; the second PDCP sequence number is determined belonging to the target PDCP sequence number set, which is used to start a first timer; an expiration of the first timer is used to trigger the first report being transmitted; the first PDCP sequence number set comprises the second PDCP sequence number.

Specifically, according to one aspect of the present application, the first PDCP PDU is used to bear a first non-unicast service;

a third signaling is received, the third signaling is used to configure a discontinuous reception of the first non-unicast service; when the first report is transmitted, a reception of the first non-unicast service is in inactive state.

Specifically, according to one aspect of the present application, at least one of PDCP SDUs indexed by the first PDCP sequence number set is transmitted.

Specifically, according to one aspect of the present application, the second node is a base station.

Specifically, according to one aspect of the present application, the second node is a relay.

Specifically, according to one aspect of the present application, the second node is a vehicle terminal.

Specifically, according to one aspect of the present application, the second node is an aircraft.

Specifically, according to one aspect of the present application, the second node is a group header.

Specifically, according to one aspect of the present application, the second node is a satellite.

The present application provides a first node for wireless communications, comprising:

a first receiver, receiving a first PDCP PDU, the first PDCP PDU comprising a first PDCP sequence number;

and

a first transmitter, when there exists PDCP SDU(s) indexed by X1 PDCP sequence number(s) in a target PDCP sequence number set not being correctly received, transmitting a first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

The present application provides a second node for wireless communications, comprising:

a second transmitter, transmitting a first PDCP PDU, the first PDCP PDU comprising a first PDCP sequence number; and

a second receiver, receiving a first report; a transmitter of the first report, in response to there existing PDCP SDU(s) indexed by X1 PDCP sequence number(s) in a target PDCP sequence number set not being correctly received, transmitting the first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the present application has the following advantages over conventional schemes:

when it comes to automatic retransmission request schemes involving L2, traditional schemes generally rely on RLC retransmissions, but MB S systems have a new requirement to simultaneously consider PTM transmission and PTP transmission. PTM uses broadcast and multicast for transmission, and PTP uses unicast for transmission. When these two transmission methods are converted, it is necessary to ensure as little data loss as possible. The two transmission methods may or may not exist simultaneously, therefore, in terms of architecture, a common anchor point can be designed for different transmission modes, so that when data transmission modes are converted, different branches have a same root node, and data can find a synchronized meta point, known as the root, on both branches, which is conducive to reducing data loss and also reducing the complexity brought by reducing data loss. This anchor point can be, for example, a PDCP entity. If automatic request retransmission is designed for this as an anchor point, such as a PDCP entity, it can be decoupled from different transmission methods without being affected by the transmission method. NR Traditional PDCP entities can provide feedback on whether reports of data are correctly received, but these reports can only be triggered under specific circumstances, such as PDCP entity reconstruction, switching, etc., while frequent transmission is not allowed; therefore, a new method of controlling the transmission of PDCP reports is needed to balance the impact of frequent transmission and reduce system complexity. The present application solves the above problems by determining a first PDCP sequence number set and transmitting a first report when there exists X1 PDCP sequence number(s) in the target PDCP sequence number set. Compared to traditional methods, it not only saves resources, but also meets the real-time retransmission needs.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first PDCP PDU, and transmitting a first report according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a protocol function according to one embodiment of the present application;

FIG. 7 illustrates a schematic diagram of multi-level PDU processing according to one embodiment of the present application;

FIG. 8 illustrates a schematic diagram of a first report according to one embodiment of the present application;

FIG. 9 illustrates a schematic diagram of a PDCP sequence number interval according to one embodiment of the present application;

FIG. 10 illustrates a schematic diagram of a PDCP sequence number interval according to one embodiment of the present application;

FIG. 11 illustrates a schematic diagram of circularly continuous PDCP sequence numbers according to one embodiment of the present application;

FIG. 12 illustrates a schematic diagram of a first PDCP sequence number being used to determine a target PDCP sequence number set according to one embodiment of the present application;

FIG. 13 illustrates a schematic diagram of a second PDCP sequence number determined belonging to a target PDCP sequence number set being used to start a first timer according to one embodiment of the present application;

FIG. 14 illustrates a schematic diagram of an expiration of a first timer being used to trigger transmitting a first report according to one embodiment of the present application;

FIG. 15 illustrates a schematic diagram of a processor in a first node according to one embodiment of the present application;

FIG. 16 illustrates a schematic diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

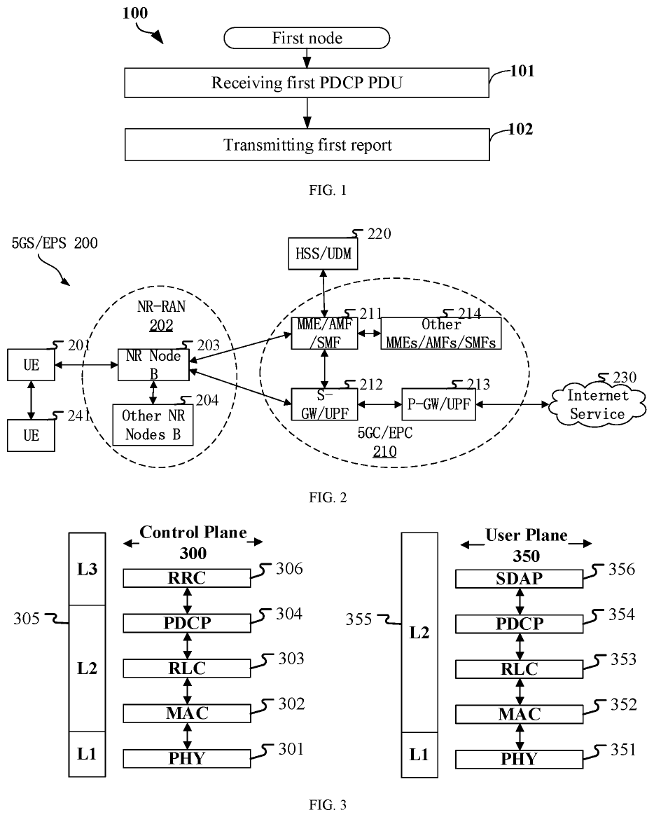

Embodiment 1 illustrates a flowchart of receiving a first PDCP PDU and transmitting a first report according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first PDCP PDU in step 101; receives a first report in step 102;

herein, the first PDCP PDU comprises a first PDCP sequence number; when there exists PDCP SDU(s) indexed by X1 PDCP sequence number(s) in a target PDCP sequence number set not being correctly received, transmitting a first report; herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the first node is a User Equipment (UE).

In one embodiment, the first node is in Radio Resource Control (RRC) connected state.

In one embodiment, the first node is in RRC idle state or RRC Inactive state.

In one embodiment, the first PDCP PDU is used bear a first service, and the first service is non-unicast service.

In one embodiment, the first service comprises a Multicast/Broadcast Service (MBS).

In one embodiment, the first service comprises Broadcast service.

In one embodiment, the first service comprises Multicast service.

In one embodiment, the first service comprises groupcast service.

In one embodiment, the first service comprises Multimedia Broadcast Multicast Service (MBMS).

In one embodiment, the first service comprises Enhanced Multimedia Broadcast Multicast Service (eMBMS).

In one embodiment, the first service comprises groupcast or broadcast service for V2X.

In one embodiment, the first service comprises groupcast or broadcast service based on NR.

In one embodiment, the first PDCP PDU uses a first bearer; bearer services provided by a PDCP entity corresponding to the first PDCP PDU to a higher layer is a first bearer.

In one embodiment, the first bearer comprises a DRB.

In one embodiment, the first bearer comprises an MRB.

In one embodiment, the first bearer comprises an SC-MRB.

In one embodiment, the first bearer comprises a unicast bearer.

In one embodiment, the first bearer comprises a multicast bearer.

In one embodiment, the first bearer comprises an MRB transmitted in Point to point (PTP) method.

In one embodiment, the first bearer comprises a multicast bearer transmitted in Point to point (PTP) method.

In one embodiment, the first bearer comprises a multicast bearer transmitted in Point to Multipoint (PTM) method.

In one embodiment, the first bearer is a radio bearer.

In one embodiment, the first bearer is an RLC bearer.

In one embodiment, the first bearer comprises an RLC bearer.

In one embodiment, the first bearer is an SL-RB.

In one embodiment, the first bearer comprises a PTP branch.

In one embodiment, the PTP branch comprises leg.

In one embodiment, the PTP branch comprises link.

In one embodiment, the PTP branch comprises branch.

In one embodiment, the first bearer comprises a PTM branch.

In one embodiment, the PTM branch comprises leg.

In one embodiment, the PTM branch comprises link.

In one embodiment, the PTM branch comprises branch.

In one embodiment, a physical channel occupied by the first PDCP PDU comprises a PDSCH.

In one embodiment, a physical channel occupied by the first PDCP PDU comprises a PSSCH.

In one embodiment, a physical channel occupied by the first PDCP PDU comprises a PSCCH.

In one embodiment, a logical channel occupied by the first PDCP PDU comprises an MTCH.

In one embodiment, a logical channel occupied by the first PDCP PDU comprises an SC-MTCH.

In one embodiment, a logical channel occupied by the first PDCP PDU comprises a DTCH.

In one embodiment, a serving cell of the first node indicates a configuration of the first bearer through an SIB.

In one embodiment, a serving cell of the first node indicates a configuration of the first bearer through an RRC signaling.

In one embodiment, a serving cell of the first node indicates a configuration of the first bearer through an RRCConnectionReconfiguration signaling.

In one embodiment, a serving cell of the first node indicates a configuration of the first bearer through an RRCReconfiguration signaling.

In one embodiment, the first service is transmitted through the method of PTM and PTP at the same time.

In one embodiment, a transmission method of the first service at least comprises PTM.

In one embodiment, DCI used to schedule the first service uses a G-RNTI for scrambling.

In one embodiment, DCI used to indicate time-frequency resources occupied by the first PDCP uses a G-RNTI for scrambling.

In one embodiment, DCI used to indicate time-frequency resources occupied by the first PDCP indicates a G-RNTI.

In one embodiment, DCI used to indicate time-frequency resources occupied by the first bearer uses a G-RNTI for scrambling.

In one embodiment, any two PDCP sequence numbers in the target PDCP sequence number set are different.

In one embodiment, X1 is greater than 0.

In one embodiment, X1 is fixed as 1.

In one embodiment, X1 is greater than 1.

In one embodiment, X1 is configurable.

In one embodiment, order of PDCP sequence numbers in the target PDCP sequence number set is continuous.

In one embodiment, PDCP sequence numbers in the target PDCP sequence number set are continuous.

In one embodiment, PDCP sequence numbers in the target PDCP sequence number set are circularly continuous.

In one embodiment, PDCP sequence numbers in the target PDCP sequence number set are circularly continuous, and a circular period is 2^{[pdcp-SN-SizeDL]-1}, where pdcp-SN-SizeDL is equal to 12 or 18, which is configured by a serving cell.

In one embodiment, order of PDCP sequence numbers in the target PDCP sequence number set is before the first PDCP sequence number.

In one embodiment, any PDCP sequence number in the target PDCP sequence number set and the first PDCP sequence number are discontinuous.

In one embodiment, any PDCP sequence number in the target PDCP sequence number set and the first PDCP sequence number are circularly discontinuous.

In one embodiment, a PDCP sequence number in the target PDCP sequence number set and the first PDCP sequence number are continuous.

In one embodiment, order of a last PDCP sequence number in the target PDCP sequence number set and order of the first PDCP sequence number are continuous.

In one embodiment, the order is circularly continuous.

In one embodiment, a PDCP sequence number in the target PDCP sequence number set and the first PDCP sequence number are circularly continuous.

In one embodiment, the sequence number is sequence number.

In one embodiment, the sequence number is an SN.

In one embodiment, X1 is an integer; X is an integer.

In one embodiment, X1 is greater than or equal to X.

In one embodiment, the first PDCP sequence number set at least comprises a PDCP sequence number.

In one embodiment, when the first PDCP sequence number set is not a PDCP sequence number, which is used to indicate that X1 is equal to 0.

In one embodiment, the first PDCP sequence number set belongs to the target PDCP sequence number set.

In one embodiment, a header of the first PDCP PDU comprises the first PDCP sequence number.

In one embodiment, sequence numbers in the target PDCP sequence number set are different; PDCP SDUs indexed by sequence numbers in the target PDCP sequence number set are different.

In one embodiment, the first report comprises a status report.

In one embodiment, the first report comprises a PDCP status report.

In one embodiment, the phrase that “the first report indicates that a PDCP SDU indexed by a first PDCP sequence number set is not received” comprises: a PDCP SDU indexed by the first PDCP sequence number set is not received by a PDCP entity associated with the first bearer.

In one embodiment, the phrase that “the first report indicates that a PDCP SDU of a first PDCP sequence number set index is not received” comprises: a PDCP SDU indexed by the first PDCP sequence number set is not received by the PDCP entity used for receiving the first PDCP PDU.

In one embodiment, the phrase that “the first report indicates that a PDCP SDU indexed by a first PDCP sequence number set is not received” comprises: a PDCP SDU indexed by the first PDCP sequence number set is not correctly received.

In one embodiment, the phrase that “the first report indicates that a PDCP SDU indexed by a first PDCP sequence number set is not received” comprises: the first PDCP sequence number set belongs to the target PDCP sequence number set.

In one embodiment, the first bearer comprises an AM bearer.

In one embodiment, the first bearer comprises a UM bearer.

In one embodiment, a higher layer does not request a reconstruction of a PDCP entity associated with the first PDCP PDU, the higher layer does not request a recovery of PDCP entity data associated with the first PDCP PDU, the higher layer does not request uplink data exchange, and the higher layer does not request a release of Dual Active Protocol Stack (DAPS) by a PDCP entity associated with the first PDCP PDU.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports NTN communications.

In one embodiment, the UE 201 supports communications within networks with large delay differences.

In one embodiment, the UE 201 supports V2X transmission.

In one embodiment, the UE 201 supports MBS transmission.

In one embodiment, the UE 201 supports MBMS transmission.

In one embodiment, the gNB 203 corresponds to the second node in the present application.

In one embodiment, the gNB 203 supports NTN communications.

In one embodiment, the gNB 203 supports communications within networks with large delay differences.

In one embodiment, the gNB 203 supports V2X transmission.

In one embodiment, the gNB 203 supports MBS transmission.

In one embodiment, the gNB 203 supports MBMS transmission.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively.? which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression fora higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first PDCP PDU in the present application is generated by the PDCP 354 or PDCP 304.

In one embodiment, the second PDCP SDU in the present application is generated by the PDCP 354 or PDCP 304.

In one embodiment, the first signaling in the present application is generated by the PHY 301 or PHY 351 or MAC 302 or MAC 352 or RLC 303 or RLC 353 or RRC 306 or NAS.

In one embodiment, the second signaling in the present application is generated by the PHY 301 or PHY 351 or MAC 302 or MAC 352 or RLC 303 or RLC 353 or RRC 306 or NAS.

In one embodiment, the third signaling in the present application is generated by the PHY 301 or PHY 351 or MAC 302 or MAC 352 or RLC 303 or RLC 353 or RRC 306 or NAS.

### Embodiment 4

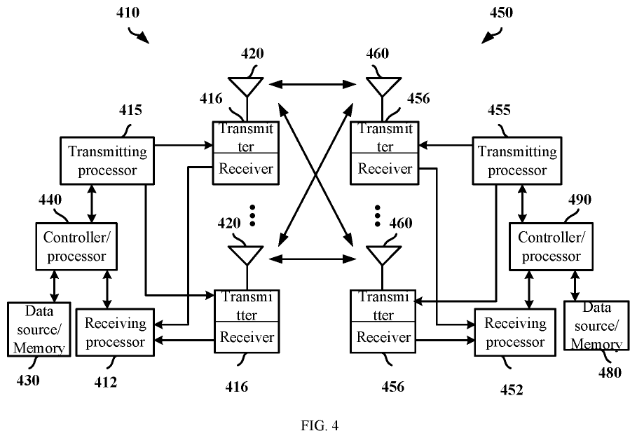

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first PDCP PDU, the first PDCP PDU comprises a first PDCP sequence number; when there exists PDCP SDU(s) indexed by X1 PDCP sequence number(s) in a target PDCP sequence number set not being correctly received, transmitting a first report; herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the first communication device 450 comprises at least one processor and at least one memory. a memory that stores a computer readable instruction program. The computer readable instruction program generates an action when executed by at least one processor. The action includes: receiving a first PDCP PDU, the first PDCP PDU comprising a first PDCP sequence number; in response to there existing PDCP SDU(s) indexed by X1 PDCP sequence number(s) in a target PDCP sequence number set not being correctly received, transmitting a first report; herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first PDCP PDU, the first PDCP PDU comprises a first PDCP sequence number; receives a first report; a transmitter of the first report, in response to there existing PDCP SDU(s) indexed by X1 PDCP sequence number(s) in a target PDCP sequence number set not being correctly received, transmitting the first report; herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the second communication device 410 comprises a memory that stores a computer readable instruction program. The computer readable instruction program generates an action when executed by at least one processor. The action includes: transmitting a first PDCP PDU, the first PDCP PDU comprising a first PDCP sequence number; receiving a first report; a transmitter of the first report, in response to there existing PDCP SDU(s) indexed by X1 PDCP sequence number(s) in a target PDCP sequence number set not being correctly received, transmitting the first report; herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the receiver 456 (including the antenna 460), the receiving processor 452 and the controller/processor 490 are used to receive the first PDCP PDU in the present application.

In one embodiment, the receiver 456 (including the antenna 460), the receiving processor 452 and the controller/processor 490 are used to receive the first signaling in the present application.

In one embodiment, the receiver 456 (including the antenna 460), the receiving processor 452 and the controller/processor 490 are used to receive the second signaling in the present application.

In one embodiment, the receiver 456 (including the antenna 460), the receiving processor 452 and the controller/processor 490 are used to receive the third signaling in the present application.

In one embodiment, the transmitter 456 (including the antenna 460), the transmitting processor 455 and the controller/processor 490 are to transmit the first report in the present application.

In one embodiment, the transmitter 416 (including the antenna 420), the transmitting processor 412 and the controller/processor 440 are used to transmit the first PDCP PDU in the present application.

In one embodiment, the transmitter 416 (including the antenna 420), the transmitting processor 412 and the controller/processor 440 are used to transmit the second PDCP SDU in the present application.

In one embodiment, the transmitter 416 (including the antenna 420), the transmitting processor 412 and the controller/processor 440 are used to transmit the first signaling in the present application.

In one embodiment, the transmitter 416 (including the antenna 420), the transmitting processor 412 and the controller/processor 440 are used to transmit the second signaling in the present application.

In one embodiment, the transmitter 416 (including the antenna 420), the transmitting processor 412 and the controller/processor 440 are used to transmit the third signaling in the present application.

In one embodiment, the receiver 416 (including the antenna 420), the receiving processor 412 and the controller/processor 440 are used to receive the first report in the present application.

### Embodiment 5

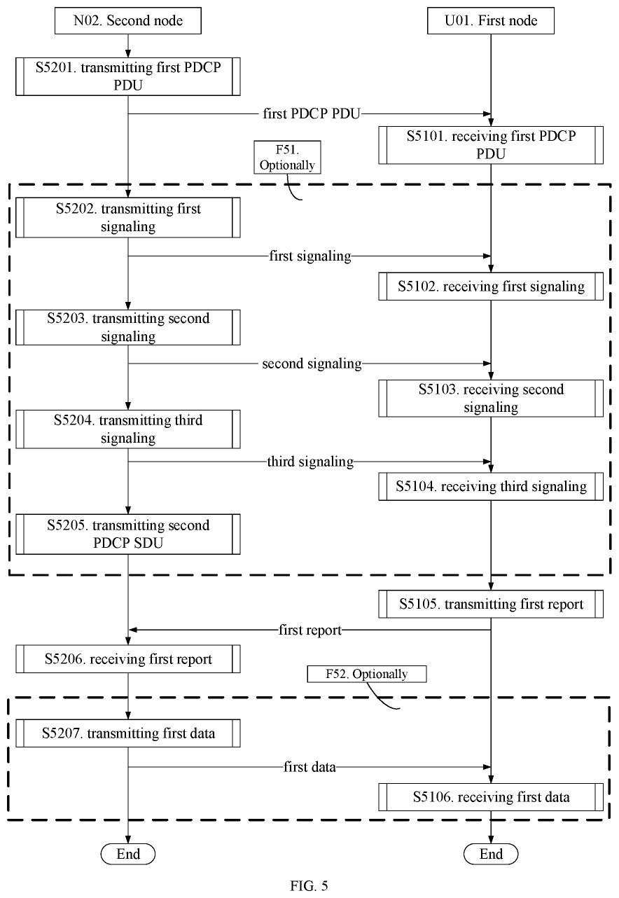

Embodiment 5 illustrates a flowchart of radio signal transmission according to one embodiment in the present application, as shown in FIG. 5. In FIG. 5, U01 corresponds to a first node in the present application, N02 corresponds to a second node in the present application. It is particularly underlined that the order illustrated in the embodiment does not put constraints over sequences of signal transmissions and implementations and steps in F51 and F52 are optional.

The first node U01 receives a first PDCP PDU in step S5101; receives a first signaling in step S5102; receives a second signaling in step S5103; receives a third signaling in step S5104; transmits a first report in step S5105; receives first data in step S5106.

The second node N02 transmits the first PDCP PDU in step S5201; transmits the first signaling in step S5202; transmits the second signaling in step S5203; transmits the third signaling in step S5204; transmits a second PDCP SDU in step S5205; receives the first report in step S5206; transmits the first data in step S5207.

In embodiment 5, the first PDCP PDU comprises a first PDCP sequence number; when there exists PDCP SDU(s) indexed by X1 PDCP sequence number(s) in a target PDCP sequence number set not being correctly received, transmitting a first report; the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the second node N02 is a serving cell of the first node U01.

In one embodiment, the second node N02 is a relay of the first node U01.

In one embodiment, the second node N02 is a PCell of the first node U01.

In one embodiment, the second node N02 is a PSCell of the first node U01.

In one embodiment, the second node N02 is an MCG of the first node U01.

In one embodiment, the second node N02 is an SCG of the first node U01.

In one embodiment, the second node N02 is a target cell of the first node U01.

In one embodiment, the second node N02 is a source cell of the first node U01.

In one embodiment, the first PDCP PDU is used bear a first service, and the first service is a non-unicast service.

In one embodiment, the first PDCP PPDU uses a first bearer, and the first bearer is a non-unicast bearer.

In one embodiment, QoS of services carried by the first PDCP PDU requires reliability.

In one embodiment, the first PDCP PDU uses a non-unicast bear to support ARQ.

In one embodiment, the first signaling comprises an SIB.

In one embodiment, the first signaling comprises an SCPTMConfiguration message.

In one embodiment, the first signaling comprises an RRCReconfiguration message.

In one embodiment, the first signaling comprises an RRCConnectionReconfiguration message.

In one embodiment, the first signaling indicates X2; order of PDCP sequence numbers in the target PDCP sequence number set is continuous, and a number of PDCP sequence number(s) between a last PDCP sequence in the target PDCP sequence number set and the first PDCP sequence number is X2.

In one embodiment, the first signaling indicates X2; order of PDCP sequence numbers in the target PDCP sequence number set is continuous, and a number of PDCP sequence number(s) between a last PDCP sequence in the target PDCP sequence number set and the first PDCP sequence number is greater than X2.

In one embodiment, order of PDCP sequence numbers in the target PDCP sequence number set is circularly continuous.

In one embodiment, X1 is 1.

In one embodiment, X is the same as X2.

In one embodiment, X is the Q1-th power of 2, and Q1 is a number of bit(s) in a PDCP sequence number.

In one embodiment, X is equal to a difference value of subtracting 1 from the Q1-th power of 2, and Q1 is a number of bit(s) in a PDCP sequence number.

In one embodiment, X2 is related to QoS requirement of the first service.

In one embodiment, QoS requirements of the first service are used to determine X2.

In one embodiment, the first signaling explicitly indicates X2.

In one embodiment, the first signaling is transmitted in a broadcast and groupcast way.

In one embodiment, the first signaling is transmitted in a unicast way.

In one embodiment, the second signaling comprises an SIB.

In one embodiment, the second signaling comprises an SCPTMConfiguration message.

In one embodiment, the second signaling comprises an RRCReconfiguration message.

In one embodiment, the second signaling comprises an RRCConnectionReconfiguration message.

In one embodiment, the second signaling indicates X3 time unit(s); order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

In one embodiment, a duration of the time unit does not exceed 1 ms.

In one embodiment, the time unit is slot.

In one embodiment, the time unit is ms.

In one embodiment, the time unit is sub-frame.

In one embodiment, the time unit is frame.

In one embodiment, the time unit is s.

In one embodiment, X1 is 1.

In one embodiment, X is the same as X3.

In one embodiment, X is the Q1-th power of 2, and Q1 is a number of bit(s) in a PDCP sequence number.

In one embodiment, X is equal to a difference value of subtracting 1 from the Q1-th power of 2, and Q1 is a number of bit(s) in a PDCP sequence number.

In one embodiment, X1 is equal to X, order of a last PDCP sequence number arranged in the target PDCP sequence number set and order of the first PDCP sequence number are continuous.

In one embodiment, order of a last PDCP sequence number in the target PDCP sequence number set and order of the first PDCP sequence number are circularly continuous.

In one embodiment, X3 is related to QoS requirement of the first service.

In one embodiment, QoS requirement of the first service is used to determine X3.

In one embodiment, the second signaling explicitly indicates the X3.

In one embodiment, the second signaling is transmitted in a broadcast and groupcast way.

In one embodiment, the second signaling is transmitted in a unicast way.

In one embodiment, X1 is equal to X, and order of a last PDCP sequence number arranged in the target PDCP sequence number set and order of the first PDCP sequence number are continuous.

In one embodiment, X1 is equal to X, and order of a last PDCP sequence number arranged in the target PDCP sequence number set and order of the first PDCP sequence number are circularly continuous.

In one embodiment, the third signaling comprises an SIB.

In one embodiment, the third signaling comprises an SCPTMConfiguration message.

In one embodiment, the third signaling comprises partial fields in an SCPTMConfiguration message.

In one embodiment, the third signaling comprises an RRCReconfiguration message.

In one embodiment, the third signaling comprises an RRCConnectionReconfiguration message.

In one embodiment, the third signaling comprises an MAC CE.

In one embodiment, the third signaling comprises DCI.

In one embodiment, the third signaling is only a time length of discontinuous reception.

In one embodiment, the third signaling is only a time period of discontinuous reception.

In one embodiment, the third signaling is only a time offset of discontinuous reception.

In one embodiment, the third signaling is only a continuous reception time length of discontinuous reception.

In one embodiment, the third signaling is used to configure a discontinuous reception of the first non-unicast service; when the first report is transmitted, a reception of the first non-unicast service is in inactive state.

In one embodiment, the first non-unicacst service is the first service.

In one embodiment, the first report can only be transmitted when the first non-unicast service is in a discontinuous receiving state.

In one embodiment, the discontinuous reception is DRX.

In one embodiment, the inactive state is inactive state.

In one embodiment, the inactive state is a state when an inactivity timer is running.

In one embodiment, the inactive state is a state other than onduration.

In one embodiment, the inactive state is a state when drx-InactivityTimerSCPTM is running.

In one embodiment, the inactive state refers to a state where a scheduling of the first service is completed and a next scheduling is not started.

In one embodiment, the inactive state is a state when receiving data of the first service is suspended.

In one embodiment, the first node U01 transmits a report in each scheduling period.

In one embodiment, the first node U01 transmits a report at most in each scheduling period.

In one embodiment, each scheduling period comprises an onduration.

In one embodiment, the report comprises a PDCP status report.

In one embodiment, the second PDCP SDU is different from a PDCP SDU comprised in the first PDCP PDU.

In one embodiment, the second PDCP SDU is used to bear the first service.

In one embodiment, the second PDCP sequence number is less than the first PDCP sequence number.

In one embodiment, the second PDCP sequence number belongs to the target PDCP sequence number set, and the second PDCP sequence number indexes a second PDCP SDU; the second PDCP sequence number is determined belonging to the target PDCP sequence number set, which is used to start a first timer; an expiration of the first timer is used to trigger the behavior of the first transmitter transmitting the first report; the first PDCP sequence number set comprises the second PDCP sequence number.

In one embodiment, when the first timer expires, and when there exists PDCP SDU(s) indexed by X1 PDCP sequence number(s) in the target PDCP sequence number set is(are) not correctly received, the first node U01 transmits the first report.

In one embodiment, a first PDCP entity is a PDCP entity receiving the first PDCP PDU.

In one embodiment, the first PDCP sequence number set comprises PDCP sequence numbers corresponding to all missing PDCP SDUs before a state variable RX_REORD maintained by the first PDCP entity.

In one embodiment, a PDCP SDU indexed by a last PDCP sequence number in the first PDCP sequence number set is the latest received PDCP SDU indexed by a PDCP sequence number in the first PDCP sequence number set.

In one embodiment, the third signaling configures the first timer.

In one embodiment, the second signaling configures the first timer.

In one embodiment, the first signaling configures the first timer.

In one embodiment, a length of the first timer is t-Reordering.

In one embodiment, a length of the first timer is less than t-Reordering.

In one embodiment, a length of the first timer is 1/N of t-Reordering, N being a positive integer.

In one embodiment, a length of the first timer is related to QoS of the first service.

In one embodiment, a transmission of the first report is unrelated to whether the first bearer is an AM bearer or a UM bearer.

In one embodiment, the first report indicates a PDCP sequence number arranged in the front in the first PDCP sequence number set.

In one embodiment, the first report indicates a minimum PDCP sequence number in the first PDCP sequence number set.

In one embodiment, the first report indicates a maximum PDCP sequence number in the first PDCP sequence number set.

In one embodiment, the first report indicates a PDCP sequence number arranged in the last in the first PDCP sequence number set.

In one embodiment, the first report comprises a first bitmap, each bit in the first bitmap corresponds to a PDCP sequence number, a first bit is any bit in the first bitmap, the first bit is 0, which represents that a PDCP SDU indexed by a PDCP sequence number corresponding to the first bit is not received; the first bit is 1, which represent that a PDCP SDU indexed by a PDCP sequence number corresponding to the first bit is received.

In one embodiment, the first report comprises a first bitmap, each bit in the first bitmap corresponds to a PDCP SDU, a first bit is any bit in the first bitmap, the first bit is 0, which represents that a PDCP SDU corresponding to the first bit is not received; the first bit is 1, which represent that a PDCP SDU indexed by a PDCP sequence number corresponding to the first bit is received.

In one embodiment, the first data is at least one of PDCP SDUs indexed by the first PDCP sequence number set.

In one embodiment, the first data comprises at least one of PDCP SDUs indexed by the first PDCP sequence number set.

In one embodiment, the first data comprises PDCP SDUs indexed by the first PDCP sequence number set.

In one embodiment, the first data comprises a retransmitted PDCP SDU.

### Embodiment 6

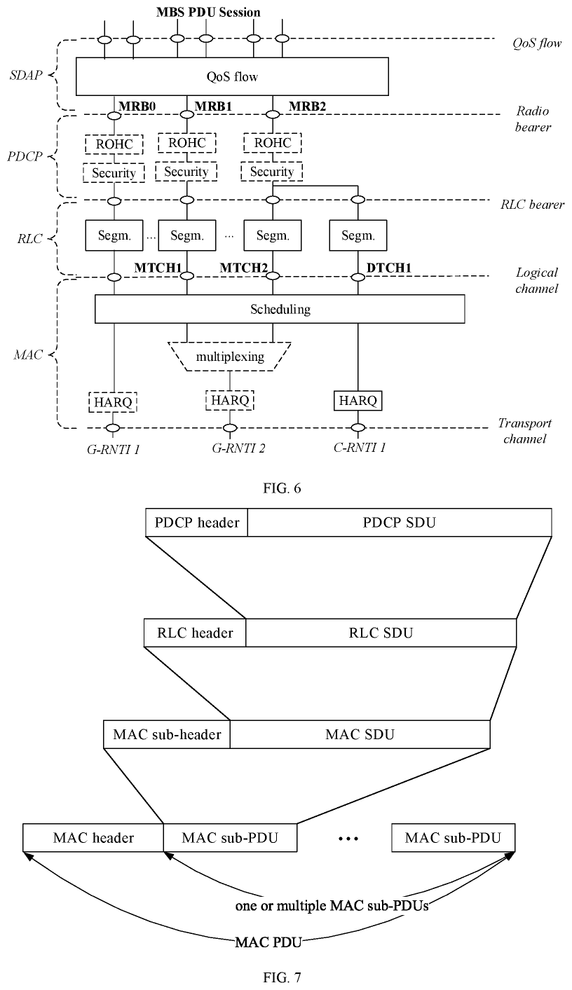

Embodiment 6 illustrates a schematic diagram of protocol function according to one embodiment of the present application, as shown in FIG. 6. In FIG. 6, functions in the dotted boxes are optional.

In embodiment 6, one or multiple MBS PDU sessions comprise one or multiple QoS flows, and the one or multiple QoS flows are mapped to one or multiple MBS bearers through an SDAP entity. An MBS bearer comprises MRB0, MRB1 and MRB2. Data mapped to an MBS bearer is processed through a corresponding PDCP entity for header compression (ROHC) and security to generate a PDCP PDU. Data received by a PDCP entity is assigned a sequence number to become a PDCP SDU. A PDCP PDU uses a corresponding RLC bearer. Functions of an RLC entity comprises segmentation. An interface between an RLC entity and a MAC entity is a logical channel, comprising MTCH1, MTCH2, and DTCH1. Herein, a PDCP PDU generated from MBS data mapped to MRB2 uses two RLC bearers, respectively corresponding to PTM transmission and PTP transmission, and is associated with two RLC entities respectively. An interface between an RLC entity and a MAC entity used for PTM transmission is MTCH2, while an interface between an RLC entity and a MAC entity used for PTP transmission is DTCH1. MBS data transmitted through MTCH1 and MTCH2 logical channels is transmitted in a PTM manner, and MB S data transmitted through DTCH1 is transmitted in a PTP manner. At the MAC layer, RLC PDUs of MTCH1 and MTCH2 are multiplexed, and an RNTI associated with a multiplexed MAC PDU is G-RNTI2. An RNTI associated with a MAC PDU generated by data from DTCH1 is a C-RNTI1. An RNTI of the first node comprises a C-RNTI1. FIG. 6 illustrates protocol functions of a transmitting end of MBS service, where Segm. is segmentation.

In one embodiment, the first node monitors DCI scrambled by the G-RNTI2.

In one embodiment, the first node monitors DCI scrambled by the C-RNTI1.

In one embodiment, the first node monitors DCI scrambled by the G-RNTI2 and C-RNTI1 at the same time.

In one embodiment, MBS data transmitted through PTM uses HARQ.

In one embodiment, MBS data transmitted through PTM does not use HARQ.

In one embodiment, MBS data transmitted through PTM uses HARQ.

In one embodiment, data transmitted by the MTCH2 and the MTCH1 uses HARQ.

In one embodiment, data transmitted by the MTCH2 and the MTCH1 does not use HARQ.

In one embodiment, an RLC entity associated with the MTCH2 does not use ARQ.

In one embodiment, an RLC entity associated with the DTCH1 does not use ARQ.

In one embodiment, an RLC entity associated with the DTCH1 uses ARQ.

In one embodiment, the MTCH2 and the DTCH1 are used together to transmit first service, and the first service is MBS service.

In one embodiment, when the first node only receives data of the first service of the DTCH1, and an RLC associated with the DTCH1 uses ARQ; when the first node receives data of the first service of the MTCH2 and the DTCH1 at the same time, an RLC entity associated with the DTCH1 does not use ARQ.

In one embodiment, at least partial UEs receive the first service through the MTCH2.

In one embodiment, at least partial UEs receive the first service through the DTCH1.

In one embodiment, at least partial UEs receive the first service through the MTCH2 and the DTCH1.

In one embodiment, the first node at least receives the first service through an MTCH2, and the first PDCP PDU is used to carry the first service.

In one embodiment, a PDCP layer in FIG. 6 uses a unidirectional ROHC.

In one embodiment, a logical channel transmitted in PTM method can be multiplexed within a MAC PDU.

In one embodiment, a logical channel transmitted in PTM method cannot be multiplexed within a MAC PDU.

In one embodiment, a logical channel transmitted in PTM method can be multiplexed with a logical channel transmitted in PTP method in a MAC PDU.

In one embodiment, a logical channel transmitted in PTM method cannot be multiplexed with a logical channel transmitted in PTP method in a MAC PDU.

In one embodiment, the MTCH2 and the DTCH1 can be multiplexed into a MAC PDU.

In one embodiment, the MTCH2 and the DTCH1 cannot be multiplexed into a MAC PDU.

In one embodiment, the first service is transmitted through the MRB2.

In one embodiment, a PDCP entity associated with the MRB2 transmits a PDCP PDU to two RLC entities at the same time.

In one embodiment, a PDCP entity associated with the MRB2 transmits a same PDCP PDU to two RLC entities at the same time.

In one embodiment, a PDCP entity associated with the MRB2 transmits a PDCP PDU to two RLC entities at the same time in a duplication method.

In one embodiment, the two RLC entities are respectively associated with the MTCH2 and the DTCH1.

In one embodiment, the second node indicates that the first node receives data of the MTCH2 and the DTCH1 at the same time.

In one embodiment, the first node reports to the second node to receive data from both the MTCH2 and the DTCH1 at the same time.

In one embodiment, a receiver of the DTCH1 only comprises the first node.

In one embodiment, data transmitted by the DTCH1 and data transmitted by the MTCH2 are the same.

In one embodiment, the DTCH1 only transmits retransmitted data.

In one embodiment, an RLC entity associated with the DTCH1 virtually transmits a PDCP PDU of a received MRB2.

In one subembodiment of the embodiment, an RLC entity associated with the MTCH2 uses AM mode.

In one subembodiment of the embodiment, an RLC entity associated with the MTCH2 uses UM mode.

In one subembodiment of the embodiment, an RLC entity associated with the DTCH1 uses AM mode.

In one subembodiment of the embodiment, an RLC entity associated with the DTCH1 uses UM mode.

In one subembodiment of the embodiment, an RLC associated with the DTCH1 virtually transmits a maintenance comprising state variable and sequence number, but not comprising transmitting an RLC PDU to lower layer.

In one subembodiment of the embodiment, an RLC associated with the DTCH1 virtually transmits calculating and updating state variable and sequence number, but not comprising transmitting an RLC PDU to lower layer.

In one subembodiment of the embodiment, an RLC associated with the DTCH1 virtually transmits calculating and updating state variable and sequence number, but not comprising generating an RLC PDU.

In one embodiment, an RLC entity associated with the MTCH2 and an RLC entity associated with the DTCH1 are configured with a same initial value of an RLC sequence number.

In one embodiment, an RLC entity associated with the MTCH2 executes a re-establishment, and an RLC entity associated with the DTCH1 is also triggered to execute a re-construction.

In one embodiment, an RLC entity associated with the MTCH2 and an RLC entity associated with the DTCH1 are configured with same lengths of RLC sequence numbers.

In one embodiment, the first node acquires the key of the security algorithm of the first service through the core network.

In one embodiment, the first service does not use encryption and integrity protection.

In one embodiment, an RLC entity associated with the MTCH2 and an RLC entity associated with the DTCH1 do not use segmentation.

In one embodiment, an RLC entity associated with the MTCH2 and an RLC entity associated with the DTCH1 uses a same segmentation.

In one embodiment, an RLC entity associated with the MTCH2 and an RLC entity associated with the DTCH1 can use different segmentations.

In one embodiment, segmentation of an RLC entity associated with the MTCH2 and segmentation of an RLC entity associated with the DTCH1 are independent.

In one embodiment, a receiving entity of the first report comprises an RLC entity associated with the DTCH1.

In one embodiment, a receiving entity of the first report comprises an RLC entity associated with the MTCH2.

In one embodiment, a receiving entity of the first report comprises a PDCP entity associated with the MRB2.

### Embodiment 7

Embodiment 7 illustrates a schematic diagram of multi-level PDU processing according to one embodiment of the present application, as shown in FIG. 7.

In one embodiment, a PDCP PDU comprises a PDCP header and a PDCP SDU.

In one embodiment, contents of a PDCP header are related to a type of an RB.

In one embodiment, a PDCP header of an SRB comprises R, R, R, R and a PDCP SN field.

In one embodiment, a PDCP header of a DRB comprises D/C, R, R, R and a PDCP SN field.

In one embodiment, a PDCP PDU optionally comprises a MAC-I field.

In one embodiment, a header of a PDCP PDU that bears a PDCP status report comprises a D/C, PDU Type, R, R, R, and an FMC field.

In one embodiment, a PDCP SDU is data.

In one embodiment, a PDCP SDU is an RRC signaling.

In one embodiment, a PDCP SDU is a PC5-S signaling.

In one embodiment, a PDCP SDU is an SDAP PDU.

In one embodiment, a PDCP SDU is an IP beared by an SDAP PDU.

In one embodiment, a PDCP SDU is MBS data.

In one embodiment, a PDCP SDU bears the first service.

In one embodiment, the PDCP SDU in FIG. 7 is the second PDCP SDU in the present application.

In one embodiment, the PDCP PDU in FIG. 7 is the first PDCP PDU in the present application.

In one embodiment, a PDCP PDU is transmitted to an RLC entity through an interface between a PDCP and an RLC entity, and an RLC SDU comprises a PDCP PDU.

In one embodiment, a PDCP PDU is transmitted to an RLC entity via an RLC bearer provided by a PDCP and an RLC entity.

In one embodiment, a PDCP PDU is transmitted an RLC layer.

In one embodiment, a PDCP PDU is transmitted to an RLC entity associated with a PDCP entity.

In one embodiment, an RLC PDU comprises an RLC header and an RLC SDU.

In one embodiment, the RLC SDU is Data data.

In one embodiment, contents of an RLC header are related to a mode of an RLC, and an RLC header of an RLC PDU in transparent mode (TMD) is empty.

In one embodiment, an RLC PDU in FIG. 7 corresponds to AM mode and UM mode.

In one embodiment, an RLC header of an RLC PDU in UM mode (UMD) comprises an SI field and an SN field.

In one embodiment, an RLC header of a UMD RLC PDU comprises one or multiple R fields.

In one embodiment, an RLC header of an AMD RLC PDU comprises a D/C field, a P field, an SI field, and an SN field.

In one embodiment, an RLC header of an AMD RLC PDU comprises one or multiple R fields.

In one embodiment, an RLC header of a status PDU comprises a D/C field and a CPT field.

In one embodiment, an RLC PDU carries data or control.

In one embodiment, an RLC PDU carries data or STATUS PDU payload.

In one embodiment, an RLC PDU is mapped to MAC layer through a logical channel interface.

In one embodiment, an RLC PDU is transmitted to MAC layer.

In one embodiment, a MAC SDU of a MAC sub-PDU is an RLC PDU.

In one embodiment, a MAC SDU of a MAC sub-PDU is a MAC CE.

In one embodiment, a MAC PDU comprises a MAC header and at least one MAC sub-PDU; the MAC header comprises a source identity, a destination identity and other bits.

In one embodiment, a MAC subPDU comprises a MAC subheader and a MAC SDU.

In one embodiment, a logical channel between RLC layer and MAC layer comprises an SCCH and an STCH as well as MTCH1, MTCH2 and DTCH1 in embodiment 6.

In one embodiment, the first service is service of interest to the first node.

### Embodiment 8

Embodiment 8 illustrates a schematic diagram of a first report according to one embodiment of the present application, as shown in FIG. 8.

In one embodiment, the first report comprises a PDCP status report.

In one embodiment, the first report comprises a D/C field, the D/C field comprises one bit, which is used to indicate whether a PDCP PDU to which the first report belongs is data or control, and a D/C field of the first report is set to control.

In one embodiment, the first report comprises a PDU Type field, and the PDU Type field indicates that a PDCP PDU to which the first report belongs is report type.

In one embodiment, R R R R field comprised in the first report is a reserved bit.

In one embodiment, the first report comprises an FMC field, the FMC field occupies 4 bytes, a value of the FMC field is set to RX_DELIV, the RX_DELIV is a state variable of a PDCP entity, which indicates a COUNT value of a first one of PDCP SDUs that has not been submitted to higher layer and is waiting.

In one embodiment, optionally the first report comprises a bitmap field, the bitmap field is a first bitmap, and a length of the first bitmap field is equal to a value between a sequence number of a PDCP SDU next to a first missing PDCP SDU to a sequence number of a last disordered PDCP SDU plus padding bit(s) so as to be byte aligned.

In one embodiment, when the first report does not comprise a bitmap field, the first report indicates that all PDCP SDUs after a PDCP SDU corresponding to a value of FMC field is not received.

In one embodiment, when the first report does not comprise a bitmap field, the first report indicates that a PDCP SDU corresponding to a value of an FMC field and all subsequent PDCP SDUs are not received.

In one embodiment, each bit in the first bitmap corresponds to a PDCP SDU.

In one embodiment, each bit in the first bitmap corresponds to a PDCP sequence number, and the PDCP sequence number indexes a PDCP SDU.

In one embodiment, a value of bit being 0 in the first bitmap represents that a PDCP SDU corresponding to the bit is not received.

In one embodiment, a value of bit being 1 in the first bitmap represents that a PDCP SDU corresponding to the bit is received.

In one embodiment, the first report indicates a first PDCP sequence number set through the first bitmap.

In one embodiment, the first report can also comprise fields not illustrated in FIG. 8.

In one subembodiment of the embodiment, the first report comprises a value of an RX_REORD status variable of a PDCP entity receiving the first service.

In one subembodiment of the embodiment, the first report comprises a value of an RX_NEXT status variable of a PDCP entity receiving the first service.

### Embodiment 9

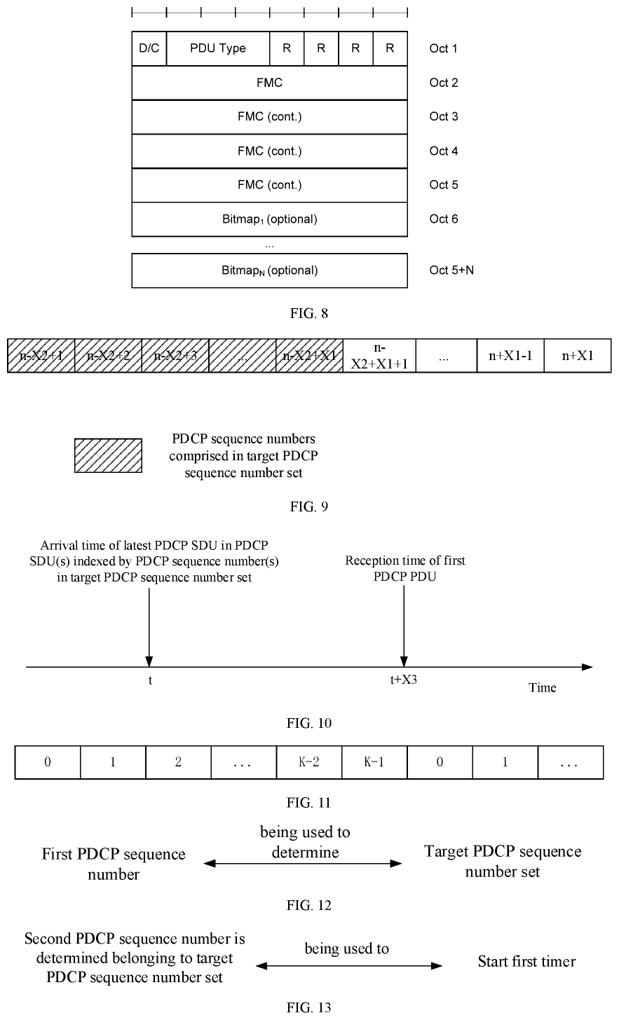

Embodiment 9 illustrates a schematic diagram of a PDCP sequence number interval according to one embodiment of the present application, as shown in FIG. 9. In FIG. 9, each box represents a PDCP sequence number, n is an integer, and a value of a PDCP sequence number is non-negative; PDCP sequence numbers are continuous.

In one embodiment, the target PDCP sequence number set comprises X1 PDCP sequence number(s).

In one embodiment, order of PDCP sequence numbers in the target PDCP sequence number set is continuous, and a number of PDCP sequence number(s) between a last PDCP sequence in the target PDCP sequence number set and the first PDCP sequence number is X2.

In one embodiment, any two PDCP sequence numbers in the target PDCP sequence number set are different.

In one embodiment, X1 is fixed as 1.

In one embodiment, X1 is greater than 1.

In one embodiment, X1 is configurable.

In one embodiment, order of PDCP sequence numbers in the target PDCP sequence number set is continuous.

In one embodiment, PDCP sequence numbers in the target PDCP sequence number set are continuous.

In one embodiment, PDCP sequence numbers in the target PDCP sequence number set are circularly continuous.

In one embodiment, order of PDCP sequence numbers in the target PDCP sequence number set is before the first PDCP sequence number.

In one embodiment, any PDCP sequence number in the target PDCP sequence number set and the first PDCP sequence number are discontinuous.

In one embodiment, any PDCP sequence number in the target PDCP sequence number set and the first PDCP sequence number are circularly discontinuous.

In one embodiment, a PDCP sequence number in the target PDCP sequence number set and the first PDCP sequence number are continuous.

In one embodiment, order of a last PDCP sequence number in the target PDCP sequence number set and order of the first PDCP sequence number are continuous.

In one embodiment, the order is circularly continuous.

In one embodiment, a PDCP sequence number in the target PDCP sequence number set and the first PDCP sequence number are circularly continuous.

In one embodiment, X1 is 1.

In one embodiment, X is the same as X2.

In one embodiment, X is Q1-th power of 2, and Q1 is a number of bit(s) in a PDCP sequence number.

In one embodiment, X is equal to a difference value of subtracting 1 from the Q1-th power of 2, and Q1 is a number of bit(s) in a PDCP sequence number.

In one embodiment, a PDCP sequence number arranged in the last in the target PDCP sequence number set is n-X2+X1.

In one embodiment, the first PDCP sequence number is n+X1.

In one embodiment, PDCP sequence numbers corresponding to all missing PDCP SDUs before n−X2+X1 belong to the target sequence number set.

In one embodiment, when the first PDCP PDU is received, PDCP sequence numbers corresponding to all missing PDCP SDUs before n−X2+X1 are determined belonging to the target sequence number set.

In one embodiment, when the first PDCP PDU is received, if a PDCP SDU indexed by sequence number n−X2+X1 is not received, the n−X2+X1 is determined belonging to the target sequence number set.

### Embodiment 10

Embodiment 10 illustrates a schematic diagram of a PDCP sequence number interval according to one embodiment of the present application, as shown in FIG. 10. In FIG. 10, an arrival time of a latest arrived PDCP SDU in PDCP SDU(s) indexed by PDCP sequence number(s) in the target PDCP sequence number set is t, and an arrival time of the first PDCP PDU is t+X3.

In one embodiment, the first signaling indicates X3 time units;

herein, order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

In one embodiment, a duration of the time unit does not exceed 1 ms.

In one embodiment, the time unit is slot.

In one embodiment, the time unit is ms.

In one embodiment, X1 is 1.

In one embodiment, X is the same as X3.

In one embodiment, X is the Q1-th power of 2, and Q1 is a number of bit(s) in a PDCP sequence number.

In one embodiment, X is equal to a difference value of subtracting 1 from the Q1-th power of 2, and Q1 is a number of bit(s) in a PDCP sequence number.

In one embodiment, when the first PDCP PDU is received at t+X3, all PDCP sequence numbers corresponding to missing PDCP SDUs determined before time t belong to the target sequence number set.

In one embodiment, after time X3 when a PDCP SDU is determined missing, a PDCP sequence number corresponding to the PDCP SDU is allowed to be added to the target PDCP sequence number set.

In one embodiment, X3 is related to T-Reordering time.

In one embodiment, X3 is equal to T-Reordering.

In one embodiment, X3 is equal to a length of an inactive time of a discontinuous reception of the first service.

### Embodiment 11

Embodiment 11 illustrates a schematic diagram of circularly continuous PDCP sequence numbers according to one embodiment of the present application, as shown in FIG. 11. In FIG. 11, each block represents a PDCP sequence number, PDCP sequence numbers are cyclically continuous based on K, the PDCP sequence numbers are integers between 0 and K−1, when an allocated PDCP sequence number reaches K−1, a next PDCP sequence number starts from 0 again.

In one embodiment, K is equal to 1024.

In one embodiment, K is equal to 4096.

In one embodiment, K is equal to 2^{[pdcp-SN-SizeDL]-1}, where pdcp-SN-SizeDL is a size of a downlink PDCP sequence number.

In one embodiment, 0 is assumed to be after K−1.

In one embodiment, for PDCP sequence numbers A and B, if a value of mod (A−B+K, K) is greater than a value of mod (B−A+K, K), it is assumed that A is arranged before B, where mod is a modulus taking operation.

### Embodiment 12

Embodiment 12 illustrates a schematic diagram of a first PDCP sequence number being used to determine a target PDCP sequence number set according to one embodiment of the present application, as shown in FIG. 12.

In one embodiment, in all missing PDCP SDUs, a PDCP sequence number whose difference value between its associated PDCP sequence number and the first sequence number within an interval is determined as the target PDCP sequence number set.

In one subembodiment of the above embodiment, a length of the interval is X2.

In one subembodiment of the above embodiment, a length of the interval is less than 2^{[pdcp-SN-SizeDL]-1}.

In one embodiment, PDCP sequence numbers corresponding to missing PDCP SDUs indexed by PDCP sequence numbers whose difference from the first sequence number is within an interval is determined as a target PDCP sequence number set.

In one subembodiment of the above embodiment, a length of the interval is X2.

In one subembodiment of the above embodiment, a length of the interval is less than 2^{[pdcp-SN-SizeDL]-1}.

In one embodiment, in all missing PDCP SDUs, PDCP sequence numbers corresponding to PDCP SDUs that determines a difference value between an missing time and a receiving time of the first PDCP PDU is within a second interval is determined as the target PDCP sequence number set.

In one subembodiment of the above embodiment, a length of the interval is X3.

In one embodiment, when the first PDCP PDU is received at t+X3, all PDCP sequence numbers corresponding to PDCP SDUs determined missing before time t belong to the target sequence number set.

In one embodiment, among PDCP sequence numbers before the first PDCP sequence number, all PDCP sequence numbers whose corresponding PDCP SDUs are not received are determined belonging to the target PDCP sequence number set.

In one embodiment, a PDCP entity that receives the first PDCP PDU is a first PDCP entity, and a reception of the first PDCP PDU triggers the first PDCP entity to update a state variable, and a state variable of the first PDCP entity is used to determine the target PDCP sequence number set.

In one embodiment, all PDCP sequence numbers preceding the first PDCP sequence number and after RX_DELIV and RX_DELIV constitute a first candidate PDCP sequence number set, and PDCP sequence numbers in the first candidate PDCP sequence number set whose indexed PDCP SDU are not received are determined as the target PDCP sequence number set.

In one embodiment, all PDCP sequence numbers preceding RX_NEXT and after RX_DELIV and

RX_DELIV constitute a first candidate PDCP sequence number set, and PDCP sequence numbers in the first candidate PDCP sequence number set whose indexed PDCP SDUs are not received are determined as the target PDCP sequence number set.

In one subembodiment of the embodiment, a reception of the first PDCP PDU is used to determine or update RX_NEXT and RX_DELIV.

In one subembodiment of the embodiment, a reception of the first PDCP PDU is used to determine the first candidate PDCP sequence number set.

In one subembodiment of the embodiment, a reception of the first PDCP PDU is used to determine a PDCP sequence number whose indexed PDCP SDU is not received in the first candidate PDCP sequence number set.

In one subembodiment of the embodiment, the first PDCP PDU is used to determine a set of missing PDCP

SDUs, and all PDCP sequence numbers before RX_NEXT and after RX_DELIV and RX_DELIV in a set of missing PDCP SDUs constitute the target PDCP sequence number set.

In one embodiment, all PDCP sequence numbers before RX_REORD and after RX_DELIV and RX_DELIV constitute a first candidate PDCP sequence number set, and PDCP sequence numbers in the first candidate PDCP sequence number set whose indexed PDCP SDUs are not received are determined as the target PDCP sequence number set.

In one subembodiment of the embodiment, a reception of the first PDCP PDU is used to determine or update RX_NEXT and RX_DELIV.

In one subembodiment of the embodiment, a reception of the first PDCP PDU is used to determine the first candidate PDCP sequence number set.

In one subembodiment of the embodiment, a reception of the first PDCP PDU is used to determine a PDCP sequence number whose indexed PDCP SDU is not received in the first candidate PDCP sequence number set.

In one subembodiment of the embodiment, the first PDCP PDU is used to determine a set of missing PDCP SDUs, and all PDCP sequence numbers before RX_REORD and after RX_DELIV and RX_DELIV in a set of missing PDCP SDUs constitute the target PDCP sequence number set.

### Embodiment 13

Embodiment 13 illustrates a schematic diagram of a second PDCP sequence number determined belonging to a target PDCP sequence number set being used to start a first timer according to one embodiment of the present application, as shown in FIG. 13.

In one embodiment, the second PDCP SDU indexed by the second PDCP sequence number is not received by the first node.

In one embodiment, a PDCP SDU indexed by a third PDCP sequence number is received, which is used to determine that the second PDCP SDU indexed by the second PDCP sequence number is not received, where the third PDCP sequence number is after the second PDCP sequence number.

In one embodiment, when the second PDCP SDU is confirmed not received, and the first timer is in stopping state, the first timer is started.

In one embodiment, when the second PDCP SDU is confirmed not received, and the first timer is in running state, the first timer is re-started.

In one embodiment, when the second PDCP SDU is confirmed not received, and the first timer is in running state, the first timer is maintained running.

In one embodiment, when the first timer is running, and a state variable RX_DELIV of a PDCP entity receiving the second PDCP SDU>=RX_REORD, the first timer is re-started.

In one embodiment, when the first timer is in a stopping state, and a state variable RX_DELIV of a PDCP entity receiving the second PDCP SDU>=RX_NEXT, the first timer is started.

In one embodiment, when the first PDCP sequence number is equal to a state variable RX_DELIV of a PDCP entity receiving the first PDCP PDU, RX_DELIV is updated as a COUNT value of a first one of PDCP SDUs that is waiting and not being received.

In one embodiment, a length of the first timer is configured by a serving cell of the first node.

In one embodiment, a length of the first timer is determined by the first node according to internal algorithm.

In one embodiment, a length of the first timer is determined by T-Reordering.

In one embodiment, a length of the first timer is equal to a determination of T-Reordering.

In one embodiment, an expiration of the first timer triggers the first node to determine the target PDCP sequence number set.

### Embodiment 14

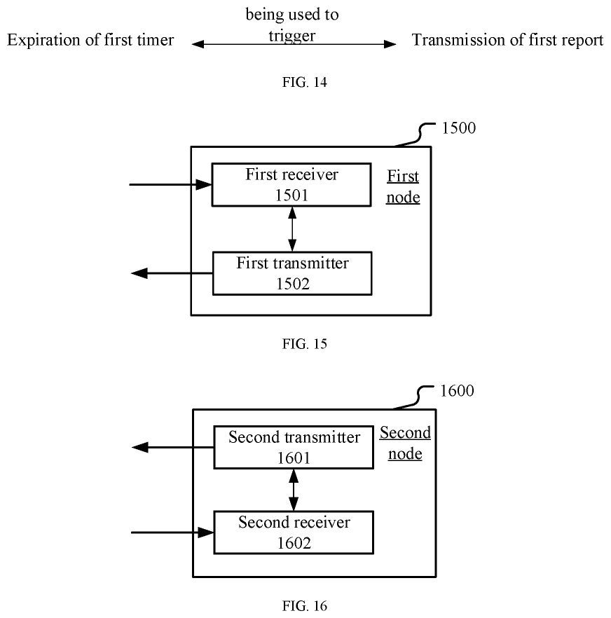

Embodiment 14 illustrates a schematic diagram of an expiration of a first timer being used to trigger a transmission of a first report according to one embodiment of the present application, as shown in FIG. 14.

In one embodiment, the first timer is a T-Reordering timer.

In one embodiment, a timing length of the first timer is determined by T-Reordering.

In one embodiment, the first timer is configured by an RRCReconfiguraton message.

In one embodiment, the first timer is configured by PDCP-Config.

In one embodiment, a length of the first timer is related to QoS requirements of the first service.

In one embodiment, a length of the first timer is related to a mode of a receiving a PDCP entity of the first PDCP PDU.

In one embodiment, a length of the first timer is related to t-Reordering.

In one embodiment, a length of the first timer is equal to 1/N of t-Reordering, N being a positive integer.

In one embodiment, a length of the first timer is equal to one of candidate values of t-Reordering.

In one subembodiment of the embodiment, a length of the first timer is equal to one of candidate values of t-Reordering that is less than t-Reordering and has a smallest difference value with t-Reordering.

In one embodiment, the first timer is configured simultaneously with a PTP transmission of the first service.

In one embodiment, the first timer is unrelated to outOfOrderDelivery.

In one embodiment, the first timer is related to outOfOrderDelivery.

In one embodiment, the first timer is related to outOfOrderDelivery, when a receiving PDCP entity of the first PDCP PDU is configured with outOfOrderDelivery, the first timer is started.

In one embodiment, when a transmission method of the first service comprises PTM, the first timer is used.

In one embodiment, when a transmission method of the first service comprises PTP, the first timer is activated.

In one embodiment, when a transmission method of the first service comprises PTM and the first bearer carrying the first service comprises uplink, the first timer is started.

In one embodiment, when a transmission method of the first service is switched from PTM to PTP, the first report is transmitted.

In one embodiment, when a transmission method of the first service is switched from PTP to PTM, the first report is transmitted.

In one embodiment, the first service is the first non-unicast service.

In one embodiment, when the first timer expires, a PDCP sequence number corresponding to a PDCP SDU whose index is not received in a PDCP sequence number interval determined by a state variable [RX_DELIV, RX_REORD) of a PDCP entity used by the first service is determined as the target PDCP sequence number set.

In one embodiment, when the first timer expires, a PDCP sequence number corresponding to a PDCP SDU whose index is not received in a PDCP sequence number interval determined by a state variable [RX_DELIV, RX_REORD) of a PDCP entity used by the first service is determined as the first PDCP sequence number set.

In one embodiment, when the first timer expires, PDCP sequence numbers belonging to a PDCP sequence number interval determined by a state variable [RX_DELIV, RX_REORD) of a PDCP entity receiving the first PDCP PDU among PDCP sequence numbers corresponding to missing PDCP SDUs are determined as the target PDCP sequence number set.

In one embodiment, when the first timer expires, PDCP sequence numbers belonging to a PDCP sequence number interval determined by a state variable [RX_DELIV, RX_REORD) of a PDCP entity receiving the first PDCP

PDU among PDCP sequence numbers corresponding to missing PDCP SDUs are determined as the first PDCP sequence number set.

In one embodiment, PDCP sequence numbers belonging to a PDCP sequence number interval determined by a state variable [RX_DELIV, RX_REORD) of a PDCP entity receiving the first PDCP PDU among PDCP sequence numbers corresponding to missing PDCP SDUs are determined as the first PDCP sequence number set, when an expiration of the first timer triggers the first node to transmit the first report.

In one embodiment, PDCP sequence numbers belonging to a PDCP sequence number interval determined by a state variable [RX_DELIV, RX_REORD) of a PDCP entity receiving the first PDCP PDU among PDCP sequence numbers corresponding to missing PDCP SDUs are determined as the target PDCP sequence number set, when an expiration of the first timer triggers the first node to transmit the first report.

In one embodiment, when the first timer expires, and if a state variable RX_DELIV of a PDCP entity receiving the first PDCP PDU entity<RX_NEXT, then the first timer is re-started.

In one embodiment, the first timer is a timer other than the t-Reordering.

In one embodiment, the first timer being in a running state is used to prohibit a transmission of the first report.

In one embodiment, the first timer is related to the reordering of a PDCP SDU.

### Embodiment 15

Embodiment 15 illustrates a structure block diagram of a processor in a first node according to one embodiment of the present application, as shown in FIG. 15. In FIG. 15, a processor 1500 in a first node comprises a first receiver 1501 and a first transmitter 1502. In Embodiment 15,

the first receiver 1501, receives a first PDCP PDU, the first PDCP PDU comprises a first PDCP sequence number;

the first transmitter 1502, when there exists PDCP SDU(s) indexed by X1 PDCP sequence number(s) in a target PDCP sequence number set not being correctly received, transmitting a first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the first receiver 1501 receives a first signaling, the first signaling indicates X2;

herein, order of PDCP sequence numbers in the target PDCP sequence number set is continuous, and a number of PDCP sequence number(s) between a last PDCP sequence in the target PDCP sequence number set and the first PDCP sequence number is X2.

In one embodiment, the first receiver 1501 receives a second signaling, and the second signaling indicates X3 time unit(s);

herein, order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

In one embodiment, X1 is equal to X, order of a last PDCP sequence number in the target PDCP sequence number set and order of the first PDCP sequence number are continuous.

In one embodiment, a second PDCP sequence number belongs to the target PDCP sequence number set, and the second PDCP sequence number indexes a second PDCP SDU; the second PDCP sequence number is determined belonging to the target PDCP sequence number set, which is used to start a first timer; an expiration of the first timer is used to trigger the behavior of the first transmitter transmitting the first report; the first PDCP sequence number set comprises the second PDCP sequence number.

In one embodiment, the first PDCP PDU is used to bear a first non-unicast service;

the first receiver 1501, receives a third signaling, the third signaling is used to configure a discontinuous reception of the first non-unicast service; when the first report is transmitted, a reception of the first non-unicast service is in inactive state.

In one embodiment, the first receiver 1501, receives at least one of PDCP SDUs indexed by the first PDCP sequence number set is received.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a device that supports transmission with low-latency and high-reliability.

In one embodiment, the first receiver 1501 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1502 comprises at least one of the antenna 452, the transmitter 454, the transmitting processor 468, the multi-antenna transmitting processor 457, the controller/processor 459, the memory 460 or the data source 467 in Embodiment 4.

### Embodiment 16

Embodiment 16 illustrates a structure block diagram of a processor in a second node according to one embodiment of the present application, as shown in FIG. 16. In FIG. 16, a processor 1600 in a second node comprises a second transmitter 1601 and a second receiver 1602. In Embodiment 16,

the second transmitter 1601, transmits a first PDCP PDU, the first PDCP PDU comprises a first PDCP sequence number;

the second receiver 1602 receives a first report; a transmitter of the first report, when there exists PDCP SDU(s) indexed by X1 PDCP sequence number(s) in a target PDCP sequence number set not being correctly received, transmitting the first report;

herein, the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

In one embodiment, the second transmitter 1601 transmits a first signaling, and the first signaling indicates X2;

herein, order of PDCP sequence numbers in the target PDCP sequence number set is continuous, and a number of PDCP sequence number(s) between a last PDCP sequence in the target PDCP sequence number set and the first PDCP sequence number is X2.

In one embodiment, the second transmitter 1601 transmits a second signaling, and the second signaling indicates X3 time unit(s);

herein, order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

In one embodiment, X1 is equal to X, order of a last PDCP sequence number in the target PDCP sequence number set and order of the first PDCP sequence number are continuous.

In one embodiment, a second PDCP sequence number belongs to the target PDCP sequence number set, and the second PDCP sequence number indexes a second PDCP SDU; the second PDCP sequence number is determined belonging to the target PDCP sequence number set, which is used to start a first timer; an expiration of the first timer is used to trigger the behavior of the first transmitter transmitting the first report; the first PDCP sequence number set comprises the second PDCP sequence number.

In one embodiment, the first PDCP PDUC is used to bear a first non-unicast service;

the second transmitter 1601 transmits a third signaling, and the third signaling is used to configure a discontinuous reception of the first non-unicast service; when the first report is transmitted, a reception of the first non-unicast service is in inactive state.

In one embodiment, the second transmitter 1601 transmits at least one of PDCP SDUs indexed by the first PDCP sequence number set is received.

In one embodiment, the second node is a base station.

In one embodiment, the second node is a satellite.

In one embodiment, the second node is a UE.

In one embodiment, the second node is a gateway.

In one embodiment, the second node is a base station that supports large delay differences.

In one embodiment, the second transmitter 1601 comprises at least one of the antenna 420, the transmitter 418, the transmitting processor 416, the multi-antenna transmitting processor 471, the controller/processor 475 or the memory 476 in Embodiment 4.

In one embodiment, the second receiver 1602 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first Packet Data Convergence Protocol (PDCP) Protocol Data Unit (PDU), the first PDCP PDU comprising a first PDCP sequence number; and
a first transmitter, in response to there existing PDCP Service Data Unit(s) (SDU(s)) indexed by X1 PDCP sequence number(s) in a target PDCP sequence number set not being correctly received, transmitting a first report;
wherein the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

2. The first node according to claim 1, wherein the first PDCP PDU is used to bear a first service; the first PDCP PDU uses a first bearer; the first bearer comprises a multicast bearer transmitted in Point to point (PTP) method; the first bearer comprises a multicast bearer transmitted in Point to Multipoint (PTM) method.

3. The first node according to claim 2, wherein the first receiver receives a first signaling, the first signaling indicates X2;
wherein order of PDCP sequence numbers in the target PDCP sequence number set is continuous, and a number of PDCP sequence number(s) between a last PDCP sequence in the target PDCP sequence number set and the first PDCP sequence number is X2.

4. The first node according to claim 3, wherein when the first PDCP PDU is received, PDCP sequence numbers corresponding to all missing PDCP SDUs before n−X2+X1 are determined to belong to the target sequence number set.

5. The first node according to claim 4, wherein Quality of Service (QoS) requirements of the first service are used to determine X2.

6. The first node according to claim 2, comprising:
the first receiver, receiving a second signaling, the second signaling indicating X3 time unit(s);
wherein order of PDCP sequence numbers in the target PDCP sequence number set is continuous, and a time interval between a time for receiving a PDCP SDU indexed by any PDCP sequence number set in the target PDCP sequence number set and a time for receiving the first PDCP PDU is not less than the X3 time unit(s).

7. The first node according to claim 6, wherein X3 is equal to a length of inactive time of a discontinuous reception of the first service.

8. The first node according to claim 7, wherein the second signaling is transmitted in the method of broadcast and multicast.

9. The first node according to claim 2, wherein X1 is equal to X, order of a last PDCP sequence number in the target PDCP sequence number set and order of the first PDCP sequence number are continuous.

10. The first node according to claim 2, wherein a second PDCP sequence number belongs to the target PDCP sequence number set, and the second PDCP sequence number indexes a second PDCP SDU; the second PDCP sequence number is determined belonging to the target PDCP sequence number set, which is used to start a first timer;
an expiration of the first timer is used to trigger the behavior of the first transmitter transmitting the first report; the first PDCP sequence number set comprises the second PDCP sequence number.

11. The first node according to claim 10, wherein the first timer is related to outOfOrderDelivery, when a receiving PDCP entity of the first PDCP PDU is configured with outOfOrderDelivery, the first timer is started; a transmission method of the first service comprises PTM, the first timer is used.

12. The first node according to claim 11, wherein when the first timer expires, and if a state variable RX_DELIV of a PDCP entity receiving the first PDCP PDU<RX_NEXT, then re-starts the first timer.

13. The first node according to claim 11, wherein the first timer in a running state is used to prohibit a transmission of the first report; the first timer is related to reordering of a PDCP SDU.

14. The first node according to claim 2, wherein the first PDCP PDU is used to bear a first non-unicast service;
the first receiver, receives a third signaling, the third signaling is used to configure a discontinuous reception of the first non-unicast service; when the first report is transmitted, a reception of the first non-unicast service is in inactive state; the first node is in Radio Resource Control (RRC) Inactive state.

15. The first node according to claim 2, wherein when a transmission method of the first service is switched from PTM to PTP, the first report is transmitted.

16. The first node according to claim 15, wherein the first report comprises a PDCP status report; the first bearer comprises an Unacknowledged Mode (UM bearer); MBS data transmitted through PTM uses Hybrid Automatic Repeat reQuest (HARQ); the first PDCP PDU is used to carry a first service, and the first service comprises a Multicast/Broadcast Service (IVIES).

17. The first node according to claim 15, wherein the first report comprises a PDCP status report; the first bearer comprises a UM bearer; MB S data transmitted through PTM does not use HARQ; the first PDCP PDU is used to carry a first service, and the first service comprises a Multicast/Broadcast Service (MBS).

18. The first node according to claim 2, wherein when a transmission method of the first service is switched from PTP to PTM, the first report is transmitted.

19. A second node for wireless communications, comprising:
a second transmitter, transmitting a first PDCP PDU, the first PDCP PDU comprising a first PDCP sequence number;
a second receiver, receiving a first report; a transmitter of the first report, in response to there existing PDCP SDU(s) indexed by X1 PDCP sequence number(s) in a target PDCP sequence number set not being correctly received, transmitting the first report;
wherein the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.

20. A method in a first node for wireless communications, comprising:
receiving a first PDCP PDU, the first PDCP PDU comprising a first PDCP sequence number;
in response to there existing PDCP SDU(s) indexed by X1 PDCP sequence number(s) in a target PDCP sequence number set not being correctly received, transmitting a first report;
wherein the first PDCP sequence number is used to determine the target PDCP sequence number set; the first report indicates that a PDCP SDU indexed by a first PDCP sequence number set is not received, the first PDCP sequence number set comprises the X1 PDCP sequence number(s), the target PDCP sequence number set comprises X PDCP sequence numbers, X1 being a positive integer not greater than X.
